(19) United States
(12) Patent Application Publication
(10) Pub. No.: US 2022/0138824 A1
(43) Pub. Date: May 5, 2022

(54) SYSTEM AND METHOD FOR TRANSFERRING A GRAPHICAL IDENTIFICATION OBJECT ONTO A PHYSICAL SUBSTRATE

(71) Applicant: ALYCE, INC., Boston, MA (US)

(72) Inventors: Joshua HERZIG-MARX, Newton, MA (US); Greg SEGALL, Watertown, MA (US); Victoria OELLERS, Watertown, MA (US)

(21) Appl. No.: 17/430,348

(22) PCT Filed: Feb. 13, 2020
(86) PCT No.: PCT/US2020/018111

§ 371 Date: Aug. 12, 2021

Related U.S. Application Data
(60) Provisional application No. 62/805,889, filed on Feb. 14, 2019.

(51) Int. Cl. G06Q 30/06; G06Q 10/08; G06F 16/955; G06Q 30/02

(52) U.S. Cl. CPC G06Q 30/0621; G06Q 10/087; G06Q 30/0633; G06Q 30/0279; G06Q 30/0623; G06F 16/955

(57) ABSTRACT

According to one or more embodiments herein, a server receives recipient information for an intended recipient of a branded item. The server generates, based on the recipient information, a custom invitation page that offers the branded item and a plurality of other options as options to the intended recipient. The server provides the custom invitation page to a client device associated with the intended recipient. The server receives, from the client device, data indicative of a selection of one of the options offered via the custom invitation page. The server initiates fulfillment of the selected option.

### RELATED APPLICATIONS

This application is a National Stage application of PCT/US2020/018111, filed Feb. 13, 2020, which claims priority to U.S. Provisional Patent Application No. 62/805,889, filed Feb. 14, 2019, both entitled SYSTEM AND METHOD FOR TRANSFERRING A GRAPHICAL IDENTIFICATION OBJECT ONTO A PHYSICAL SUBSTRATE, by Herzig-Marx et al., the contents of each of which are hereby incorporated by reference in their entirety.

### TECHNICAL FIELD

The present disclosure relates generally to the graphical identification of items. More specifically, the present disclosure relates to an improved process for transferring a graphical identification object onto a physical substrate associated with an item.

### BACKGROUND

Branded products are in widespread use throughout the world. Illustrative examples of branded products include embroidered pullover fleece jackets, squeeze balls, pens, cell phone chargers, and coffee mugs. These products can be branded to include, for example, logos or company mission statements. Branding can be incorporated into a product in a variety of ways, such as by embroidering, printing, laser etching, and the like.

Typically, branded products are distributed without consideration to the needs or wants of the recipient. For example, a company may send micro USB cell phone chargers that are branded with the company's logo to its existing customer base. Many of the recipients may already have their own chargers or may have phones that use a different connector (e.g., iPhones use lightning connectors, not micro USB). At best, the branded products will not have their intended effect on the recipients and, at worst, can lead to substantial waste, as many may simply discard the branded products.

With the proliferation of computing devices, opportunities now exist to reduce the waste of branded products and increase their effectiveness, by tailoring the distribution pipeline to each individual recipient.

### SUMMARY

In various embodiments, a server receives recipient information for an intended recipient of a branded item. The server generates, based on the recipient information, a custom invitation page that offers the branded item and a plurality of other options as options to the intended recipient. The server provides the custom invitation page to a client device associated with the intended recipient. The server receives, from the client device, data indicative of a selection of one of the options offered via the custom invitation page. The server initiates fulfillment of the selected option.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements. One or more of the drawings is submitted in color.

FIG. 1 is an example simplified diagram of a sender process according to some embodiments;

FIG. 2 is an example simplified diagram of a recipient process according to some embodiments;

FIG. 3 is an example simplified diagram of a physical invitation fulfillment process according to some embodiments;

FIG. 4 is an example simplified diagram of an item fulfillment process according to some embodiments;

FIG. 5 is an example simplified diagram of a physical item invitation according to some embodiments;

FIG. 6 is an example simplified diagram of a recipient catalog according to some embodiments;

FIG. 7 is an example simplified diagram of a computer network system according to some embodiments;

FIG. 8 is an example simplified diagram of a vendor onboarding process according to some embodiments;

FIG. 9 is an example simplified diagram of a product rendering process according to some embodiments.

FIG. 10 is an example simplified diagram of a procedure for initiating fulfillment of a selected option via a custom invitation page.

### DESCRIPTION OF EXAMPLE EMBODIMENTS/DETAILED DESCRIPTION

In the following detailed description, numerous specific details are set forth to provide a full understanding of the present disclosure. It will be apparent, however, to one ordinarily skilled in the art that embodiments of the present disclosure may be practiced without some of these specific details. In other instances, well-known structures and techniques have not been shown in detail so as not to obscure the disclosure.

There are a number of challenges associated with manufacturing and distributing branded products. Budgeting has uncertainty over how much product will be needed in a year, what the demand is, how much the product will cost, what will get used, what will get wasted, etc. Selecting items includes selecting among an array of companies supplying products, each with extensive product catalogs, then choosing (and possibly designing) the products that may appeal to the intended audience. Designing those products is complex, as it sometimes involves finding and evaluating multiple designers, then managing bids and selecting a winner, then engaging the winner and involving that designer in the process with the selected promotional product vendor. In other cases, suppliers use internal designers of varying skill and creative ability. The selected design may then be subjected to a proofing process, which may introduce additional complexity or inefficiency. Ordering the items is then a challenge as one frequently orders too few or too many, especially when there are multiple options for an item, such as clothing in sizes S, M, L, XL or Men's and Women's.

Another challenge includes over-ordering of branded products, which may result in storage at the company location or dedicated storage by a third party (at increased cost). Then, once the items are needed, whether for a trade show or an employee event or to restock supplies at an internal supply closet or conference center, inventory management can become a burden, whether it is overseen by company staff or an external organization. In the case of trade shows, promotional product is shipped across the country to different cities and conference halls, stored and retrieved and lost and found by hotels and trade show staff, or damaged or delayed in transit. And when the items make it to their destination, the recipients might not want the items in question.

A further challenge includes the lack of meaningful data or evidence to indicate how much people value the branded products, nor how well branded products work at achieving the objectives of the companies providing the products.

A system of the present disclosure may address one or more of the above-identified challenges by allowing Senders to send gifts to Recipients, where Recipients choose what they receive. Waste can be reduced because Recipients receive items they request. Instances of Senders asking Recipients personal questions (for example, “what T-shirt size are you?”) can also be reduced. Moreover, the process is tracked and measured against collected metrics to train and improve the system.

Examples of items that can be sent and received using the system might include, for a fictional ABC Company, a pen with the ABC Company logo and name on the side, in the ABC Company color, a colored T-Shirt with the ABC Company logo on it but no other markings, a Patagonia™ jacket with the ABC Company logo embroidered on the chest, etc.

When a new Sender Organization is enrolled with the system, various roles and permissions within the organization may optionally be established for the purpose of setting permissions, establishing default behaviors, and simplifying administration. Examples of roles might include Sales Executives, Junior Sales Reps, Sales VPs, Customer Care Managers, etc. Each role optionally may be associated with permissions, such as dollar-value limits for the Items they can send to Recipients of different types. Likewise, item selection rules governing Item value limits for recipients based on roles, organizations, titles, or other criteria may be set. Other defaults or behaviors may be established as well, including templates and logos the system will use for communications such as emails, desired message frequencies, budgets and payment methods, organization structures, etc. This is not an exhaustive listing of the configurability of the system, nor the levels of configuration possible. These and any other settings may optionally be updated over time and may be extended as functionality is added to the system.

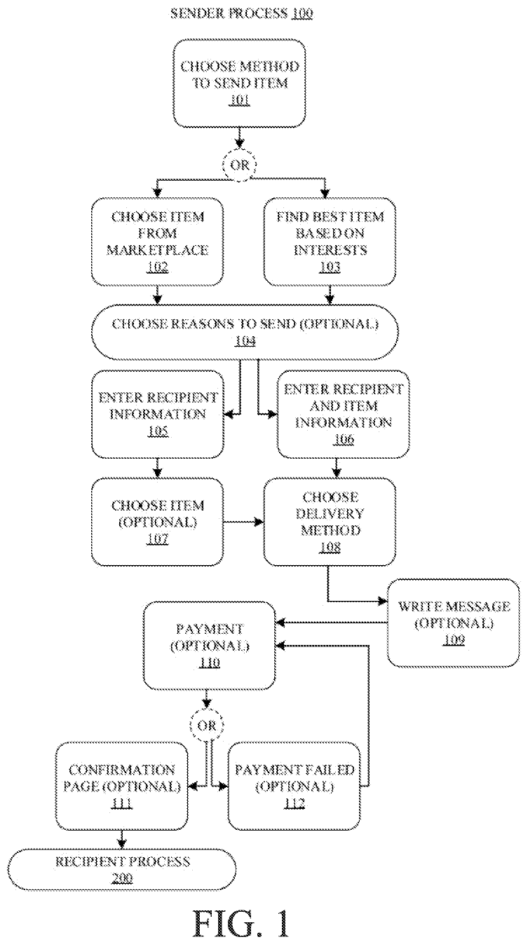

FIG. 1 illustrates a Sender Process 100 by which a Sender of an item can use the above-described system to send an item to a Recipient. In step 101, a Sender chooses the method by which they will pick the item, either by choosing the item or items from the marketplace at step 102 or having the system suggest an item or items for the Recipient at step 103, based on the Recipient's interests, characteristics, demographics/psychographics, activities, gifting moments, social media activity, past gifting history, 3rd party interest segmentation, expressed interests, or other algorithms, or based on seasonality (for example, hot chocolate mix in the winter), regional preferences (such as local sports team gear appropriate to the recipient's home address), general observed preference trends, combinations thereof, or any of a number of other potential criteria.

In step 104, the Sender can optionally pick a reason they want to send the item. This is used to help organize their items, allow for preset Message Templates, preset Delivery Methods and prepaid Credits/Payment Methods.

If the Sender chooses an item or items in step 102, then they proceed to step 105. The Sender enters in their Recipient's information, e.g., First Name, Last Name, E-Mail Address, Country they live in and optionally Actions Required from the Recipient to accept the item. Some examples of Actions Required might include the Recipient scheduling a meeting or follow-up call, completing a survey, watching a webinar, registering for a newsletter, or any other action or actions selected by the Sender or Sender's organization. Actions Required may also include actions specific to certain items, such as verification of age (for, say, a wine-of-the-month club), verification of shirt size (for a T-Shirt), preferred monogram initials (for a personalized monogrammed bathrobe), or any other item-specific Action Required. In certain embodiments, various subsets of the information provided in this step may be optional, or the information may be auto-populated by the system based on preset values, defaults, inferences by the system, or various other techniques. Actions Required may optionally be stored within the system in one or more physical or virtual locations, in any number of geographies, as well as sent to any other external system or systems in any number of other geographies. The Actions Required, as well as any patterns in the Actions Required collected by geography, or by demographic or other attribute of the Recipient, or any other may optionally be reported or analyzed, tracked, or used to trigger decisions or actions within or externally to the system.

If the Sender elected to have the system suggest item(s) based on the interests of their Recipient in step 103, then they proceed from step 104 to step 106. Just as in step 105 described above, in step 106, the Sender enters in the Recipient's information—First Name, Last Name, E-Mail Address, Country they live in and optionally Actions Required from the Recipient to accept the item. Additionally, the Sender provides at least some of the following details: The Recipient's Interests, The Recipient's Place of Work, Reason for the Gift, Relationship, Recipient's City, Recipient's State. As with step 105, in certain embodiments, various subsets of the information provided may be optional, or it may be auto-populated by the system based on preset values, defaults, inferences by the system, or various other techniques.

Collectively, the information provided by the Sender during step 106 is used to create or enhance a profile of the Recipient. In various embodiments, the system might maintain profiles for Recipients that persist indefinitely, or it may limit the time the Recipient's profile persists to the scope of a single transaction or some other length of time. Additional sources of data, such as social media profiles, public demographic and census data, and other data sources about the recipient specifically or more generally, can subsequently be harvested either manually or automatically by the system to enhance the Recipient profile and to develop predicted interests, such as sports teams (say, by looking at region and social media likes), hobbies, school affiliations, etc. Ultimately, recommended items can be identified by evaluating the enhanced profile of the Recipient along with information about the gifting occasion and other context that is both specific to the exchange (for example, what is the particular reason for the gift) or that may be unrelated to this gift in particular (for example, seasonality of gifts). This evaluation may be performed manually, using statistical analysis techniques, or through any combination of these or other methods.

Once the system has produced the recommended item(s), the Sender may optionally be presented with the item(s) recommended by the system and asked, at step 107, to select the specific item that will be sent to the Recipient as a recommendation. The Sender will be shown item(s) from which to choose. One item is chosen to be offered to the Recipient through an invitation. In some embodiments, this step may not occur. In other embodiments, the Sender may simply take no action to accept the default choice of the system.

In step 108, the Sender chooses a delivery method for the item invitation. This can be an email or physical method (e.g., a card with a code to enter on a website of the system).

In step 109, the Sender writes a message to their Recipient, including a subject line for the email. This step is optional, as the message may default to a standard message for this Sender account, for this particular user at the Sender account, to a particular templated message from a customer relationship management (CRM) system, or to any of a number of other possible methods for generating message subjects and content.

In step 110, the Sender chooses a payment method. Examples could be credit card or pre-purchased credits. In step 111, if the Payment Method is successfully processed, a confirmation page is shown to the Sender. In step 112, if the Payment Method fails to process, an error message is shown to the Sender and the Sender is returned to step 110 to choose a new payment method. In certain embodiments, one or more of the steps 110, 111, and 112 around payment processing may not be present, or default to set values based on pre-configured standards set at various levels of the hierarchy of the Sender organization, or may include intervention by different users than the Sender to resolve payment errors (for example, an administrator or the vice president of Sales of the Sender account).

Data entered by any user at any step in the process may be stored by the system for optional analysis and reporting purposes, including for the internal optimization of the performance of the system itself.

In other implementations, steps 101-110 can be performed in a different order or performed together.

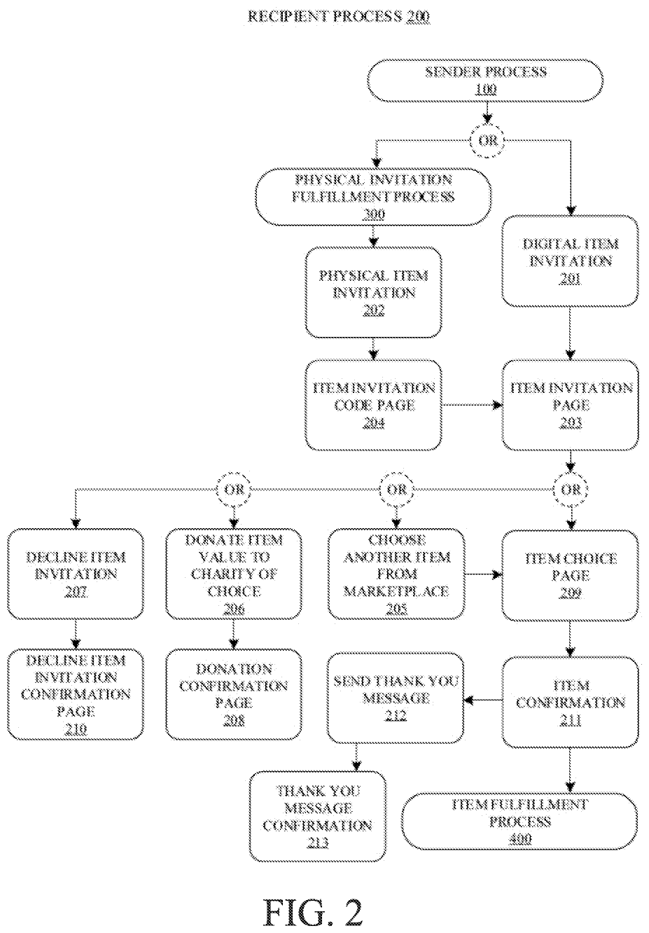

FIG. 2 illustrates a Recipient Process 200 by which a Recipient of an item can use the above-described system to receive an item once that Sender has sent the item using the Sender Process 100.

The Recipient receives either or both of a Physical Item Invitation or a Digital Item Invitation, based on the specific elections made, actions taken, defaults set, and other factors during the Sender Process 100.

In step 201, a Recipient may optionally receive a Digital Item Invitation. The Digital Item Invitation may take the form of any digital message or communication containing an Invitation Link. Examples of digital messages include, but are not limited to, emails, text messages, Facebook messages, LinkedIn messages, WhatsApp or other messaging app messages, audio tones, Bluetooth signals, NFC payloads, video messages, web pages, proprietary digital messaging protocols, in-game messages in online environments or games, or any other digital messaging medium. The subject line and message presented to the Recipient, if applicable, are those written by the Sender in step 109 or otherwise provided by the system. This Digital Item Invitation also contains an Invitation Link, which when clicked or otherwise activated by the Recipient directs the Recipient to the Item Invitation Page at step 204. The Item Invitation Link may be a uniform resource locator (URL) or a deep link into a mobile app., or any other means of directing the Recipient from the Digital Item Invitation to the Item Invitation Page.

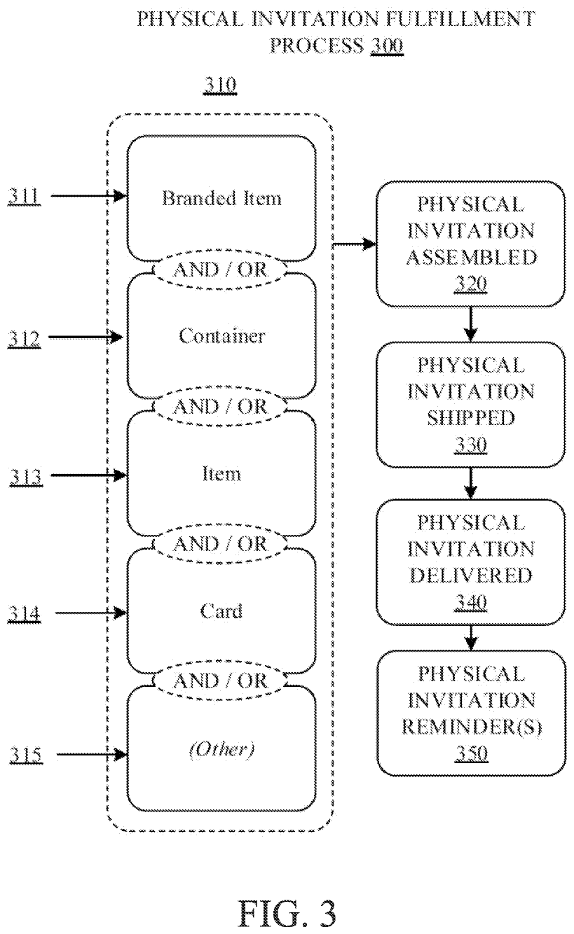

In step 300, a Recipient may optionally be sent a Physical Item Invitation if the Delivery Method chosen in step 108 was the physical option (or if the physical invitation delivery option was otherwise selected), which will be fulfilled through the Physical Invitation Fulfillment Process. That process is illustrated in detail in FIG. 3, and is described in more detail below.

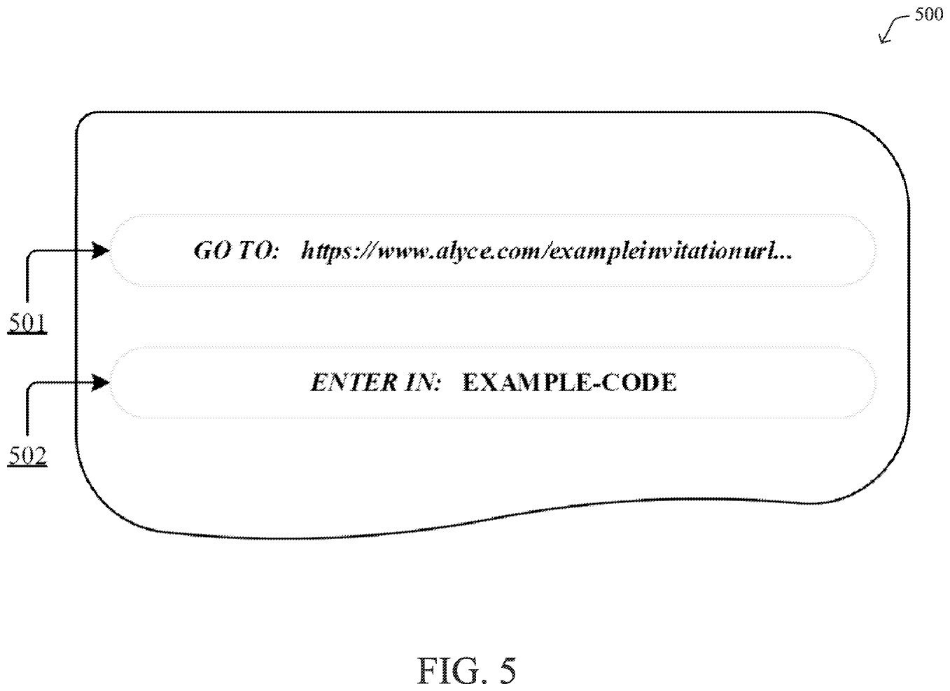

In step 202, a Recipient may optionally receive the Physical Item Invitation that was produced by the Physical Invitation Fulfillment Process. The Physical Item Invitation will provide the Recipient with an Item Invitation Code and Item Invitation URL. The code and the URL may be printed, engraved, etched, written, or otherwise marked on a physical object so that the Recipient can identify them and can use them to continue the redemption process to step 203. The object may include a dedicated print medium, such as a piece of paper or cardstock, a business card, a marketing flyer, a photograph, or any other insubstantial object; or, it could be a multi-purpose item, such as a paperweight, or a toy, or a block of wood, or a piece of metal, a branded product, such as a mug or a mousepad, or a valuable object of some sort. In either case, the Physical Item Invitation with the Item Invitation Code and the Item Invitation URL may itself be contained in an envelope or a box. More generally, the Physical Item Invitation 500, as illustrated in FIG. 5, conveys to the Recipient the Item Invitation URL 501 and the Item Invitation Code 502 so that the Recipient can advance to step 203.

After the Recipient has optionally received the Physical Item Invitation, they optionally may enter the URL provided in step 202 into a web browser, and they are taken to an Item Invitation Code Page at step 204 where they enter in the Item Invitation Code from step 202. If successful, the Recipient is brought to the Item Invitation Page at step 203. In various embodiments, the Item Invitation Page may be customized for the Recipient, such as including information about the recipient (e.g., the name of the recipient, a message for the recipient, etc.), as well as various gift options (e.g., the item selected by the Sender or the system, a charitable donation in lieu of the item, a marketplace of other options, etc.).

In step 203, the Item Invitation Page shows the suggested Item chosen by the Sender for the Recipient during either step 102 or 107, or otherwise selected by the Sender Process. Some combination of buttons or links are shown allowing the Recipient to either (a) accept the item, (b) choose another item, (c) donate the item value to charity, or (d) decline the item invitation. In various embodiments, different combinations of options (a) through (d) may be shown, and other mechanisms of presenting the action to the Recipient than buttons or links may be used, so long as the Recipient is given the ability to select one of the presented options.

If the Recipient has the option to Decline Item Invitation, at step 207, the Recipient may be presented with a button or other graphical object to decline the item invitation. If they select that option, they then proceed to step 210, Decline Item Invitation Confirmation Page. The Recipient is shown a confirmation message that they declined the Sender's item invitation. Additional information about the reason for the Recipient declining the Item Invitation, or about the interaction with the Sender or the Sender's company, or any other survey or other information or context, may optionally be collected and stored as part of steps 207 and/or 210. Both the act of the Recipient taking step 207, as well as any additional information that may optionally be gathered throughout the interaction process with the recipient may be captured and stored for both real-time and later analysis and to improve the performance of the system. Each point of interaction may be used to trigger events within the system, or to trigger communication to the Sender (such as status updates or reminders to follow up) or Recipient (such as thank-you notes, marketing literature, or other appropriate follow-ups), and to customize any of those communications based on the specific information gathered by the system. Key interactions, checkpoints, and steps taken by both the Sender and the Recipient throughout the process may optionally be exported or integrated into third-party CRM systems or other systems or tied to metrics associated with the Items that the Sender is sending. Optionally, information about interactions between the Sender or Sender organization and the Recipient or Recipient Organization outside the system may be integrated into any analysis performed.

If the Recipient has the option to Donate Item Value to Charity of Choice, at step 206, the Recipient has the option to choose a from a pre-selected list of charities to donate item value to. If they select that option, they select a charity and proceed to step 208, Donation Confirmation Page. The Recipient is shown a confirmation message. Additional information about the reason for the Recipient donating the Item's value, or about the interaction with the Sender or the Sender's company, or any other survey or other information or context, may optionally be collected and stored as part of step 206 and/or step 208. As with the Decline process, step 207 and step 210, the system optionally logs all Sender and Recipient interactions with the system, including optionally the Physical or Digital Item Invitations, and all such information may be used for analysis and reporting, optimization, statistical techniques, system triggers, messaging, general monitoring and improvements, and other purposes, as well as integration into external systems.

If the Recipient has the option to Choose Another Item from Marketplace, at step 205, then the Recipient has the option to view and choose another item within a restricted budget range from the Marketplace. The catalog of Items presented in the marketplace may optionally be filtered in several ways. The catalog of items may be curated by the system to limit the selection to those whose quality, price, reliability or other attributes are deemed suitable for the purpose of the system. Some examples of criteria for curation include, but are not limited to particular vendors, rules (for example, only 4-star-rated or above products on xyzretail.com are allowed), hand-curated items, high-margin items for the system, or other curation criteria. From the curated list of products, a particular Sender organization or Sender may optionally elect to whitelist or blacklist certain items in general (i.e., across all of their Recipients), or for a particular Recipient or type of Recipient. A Sender organization may optionally elect to whitelist or blacklist certain items for certain roles or groups of their own employees or members to send out (so, for example, ABC Corp may decide that it only wants to allow VP or above Senders to be able to send sports tickets, and that it only wants to allow SVP or above Recipients to receive those Items). ABC Corp may also decide that it wants to bar its employees from being able to send alcohol or tobacco products.

From the curated, allowable catalog that a Sender has available, it may further be filtered down by other item selection rules for a particular Recipient, such as the intended value of the Item (say, $75 or $150) or another rule the Sender or system may elect to impose. Within that curated, allowed, filtered Marketplace, the Recipient is presented with Items that satisfy the restrictions, filters, and rules applied—so, for example, they won't see options valued at $500 if the maximum Item value the Sender selected was $100. The Recipient may optionally browse the listed Items, search the Marketplace, and/or filter the marketplace further.

The system may optionally rank and display the Marketplace in such a way to show recommended items first or to increase the likelihood of Item redemption. Because in some embodiments the system integrates with data from external systems to access metrics associated with the Sender (such as sales conversions, webinar views, meetings held, etc.), the system can use data analysis and/or other techniques to optimize the Item recommendations, the Marketplace presentation and experience, and the user experience flow to increase Item conversions and other metrics selected by the Sender.

One of ordinary skill in the art will recognize that other techniques for establishing a list of products in the Marketplace may be used.

Once the Recipient has either decided to accept the Sender's initial item from the Item Invitation Page 203, or has chosen another item from the Marketplace at step 205, they are brought to the Item Choice Page 209 and presented with a form to fill in any applicable item options (i.e. size, color, age verification), address to ship to (if applicable), and any Required Actions set by the Sender. Examples of Required Actions include, but are not limited to, sign an affidavit, schedule a meeting, watch a webinar, sign up for a newsletter, or fill out a survey. Like other user actions in the system, Required Actions may be stored for real-time and off-line reporting, analysis, and machine-learning purposes, as well as other purposes. Since Required Actions can be tied to metrics selected by the Sender or Sender organization, this information provides a link between a sent Item and an Action taken by a recipient. Furthermore, because of the data trail within the system (and established with any other system or systems to which it is integrated or with which its data is associated or combined), patterns can be identified surrounding the particular Items, messages, subject lines, invitation formats, communication cadences, etc. that work best at driving the Required Actions by Recipients most desired by the Sender or Sender organization, or even the downstream outcomes such as closed sales or recurring revenue.

Upon completion of step 209, the Recipient is shown an Item Confirmation message at step 211 displaying their item of choice was received and order is processing. The Recipient is optionally able to write the Sender a thank you note in the step Send Thank You Message at step 212. If they opt to do so, this can be sent or initiated from the system or from an external system—for example, an email, CRM, or ticketing/helpdesk system—to the Sender, and the Recipient is shown a Thank You Confirmation Message at step 213 displaying their thank you message was sent to the Sender successfully. Whether or not the Recipient elected to send a thank you message, the system can initiate the Item Fulfillment Process 400 to send the Item to the Recipient.

As will be evident to one of ordinary skill in the art, the order of the steps may be modified, or one or more steps may be added or omitted, in some embodiments of the disclosed process.

FIG. 3 details a Physical Invitation Fulfillment Process 300, in which a Recipient may optionally be sent a Physical Item Invitation if the Delivery Method chosen in 108 was the physical option (or if the physical invitation delivery option was otherwise selected).

A Physical Item Invitation 310 can consist of one or more elements, according to various embodiments. Examples of those elements include Branded Item(s) 311 (such as a pen with a company logo), the Container(s) 312 (such as an envelope, or a cardboard, decorative, or wooden box), one or more Item(s) 313 (such as a pen, or a token gift, or a desk toy), Card(s) 314 (which could be composed of paper or cardboard or plastic or wood or any other material, and be printed, cut, engraved, or otherwise decorated in any way), or any Other 315 element(s) a Sender might wish to include in the Physical Item Invitation (for example, confetti, perfume, wrapping, or decorative paper). Those elements can be stored at or produced by one or more Vendors, one of which may optionally be the operator of the system itself If elements of the Physical Item Invitation are sourced from multiple Vendors, a single Vendor is responsible for assembling the Invitation and Shipping it.

Upon receiving the specifications for the Physical Item Invitation from the system from the Sender Process, The Invitation Vendor assembles the elements that are a part of the Invitation in step 320, Physical Invitation Assembled. The Invitation Vendor then ships it in step 330, Physical Invitation Shipped, to the address provided. In step 340, Physical Invitation Delivered, the Recipient receives the Invitation, and the flow can return to 202. By observing whether or not the Recipient completes step 202 or not, the system can elect when and whether to send Physical Invitation Reminder(s) 350 to the Recipient to remind the Recipient to open their Physical Item Invitation and redeem their Item.

In various embodiments the Invitation Vendor can track and report its progress in assembling the Invitation, as can the Vendors providing each element of the Physical Invitation to the Invitation Vendor. All such status, progress, and tracking information, as well as any similar information from the shipping vendor(s) used, can be stored and/or integrated and used for analysis, reporting, optimization, and various other purposes. In various embodiments, the Invitation Vendor(s) can be located in multiple locations around the world, and the same items may be held or produced in more than one location or by more than one Invitation Vendor. In some embodiments, the Invitation Vendor may correspond to the system itself. In some embodiments, different Invitation Vendors may be selected for different invitations based on attributes of the invitations themselves.

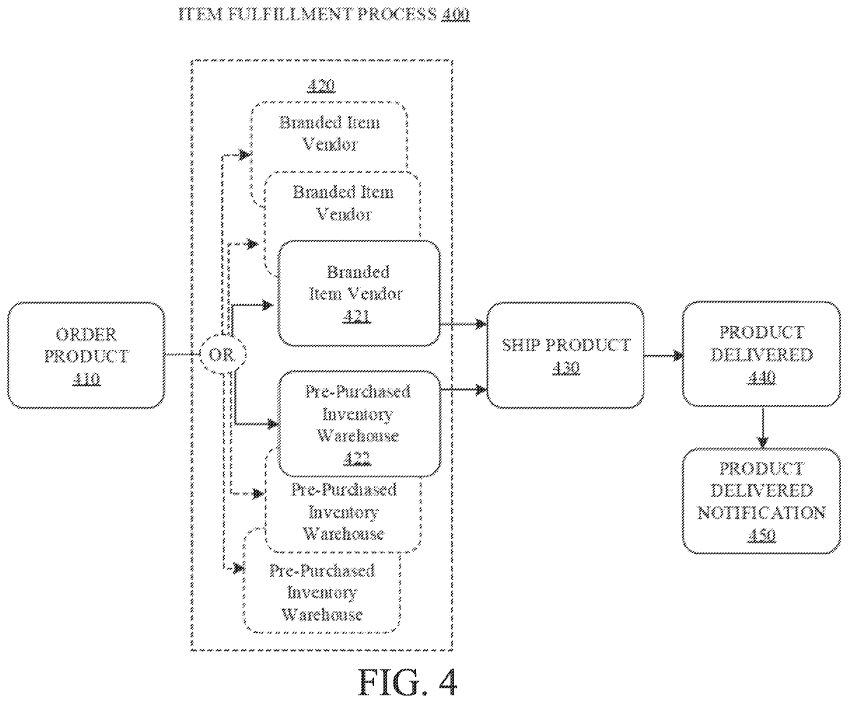

FIG. 4 illustrates an Item Fulfillment Process 400. After the Recipient has selected an Item, and optionally specified any required or optional options for that item, such as size, color, etc. in step 209, the Order Item 410 process places the order for the specific item with the Vendor 420, either through an API or manually (via email, through website, via telephone call, or some other means).

The Vendor 420 can be a One-Off Item Vendor 421, which produces or finishes and fulfills individual Items on demand, or a Pre-Purchased Inventory Warehouse 422 which stores previously-purchased Item inventory that it either produced itself or that was produced by another Vendor and shipped to it. A single entity can serve as both a One-Off Item Vendor and a Pre-Purchased Inventory Warehouse, and it optionally may do so for the same or different Items, in the same or different geographies, etc. Vendors can also be located around the world. The same Items can also be held or produced in multiple Vendor locations or by more than one Vendor.

Once the order has been placed in step 410 with the Vendor 420, the Vendor ships the Item 430 to the Recipient. The Item is delivered to the Recipient 440. An Item Delivered Notification 450, such as an e-mail, is sent from the system to the Sender letting them know the item was received by the Recipient.

In various embodiments, the Item Vendor can track and report its progress in producing and fulfilling the Item. All such status, progress, and tracking information, as well as any similar information from the shipping vendor(s) used, can be stored and/or integrated and used for analysis, reporting, optimization, and various other purposes.

In some embodiments, a Sender may send an item with the Sender's company logo and/or colors and/or other design elements. The logos and colors and designs can be applied to specified products, collections of products, broad sets of products, or entire vendor's or multiple vendors' catalog(s) of products to create a Custom Branded Marketplace for that particular Sender Organization. The system can host multiple Custom Branded Marketplaces for different Sender organizations, or for multiple groups within a Sender organization. The method of sending the Invitation may change based on the context, such as bulk physical and digital Invitation distribution at trade shows and events as well as for “kitting” multiple items into a single Invitation. After accepting an invitation, the Recipient's view of the Recipient Catalog may then include items with the Custom Branding applied.

In some embodiments, a Sender Organization may provide one or more graphical identification objects to the system to create its associated Custom Branded Marketplace. The graphical identification objects visually identify the Sender or Sender Organization and may include image objects, text objects, hybrid objects that include attributes of image and text (e.g., stylized text), or the like. Typical examples of graphical identification objects include, but are not limited to, a logo or symbol, colors or color schemes, a mascot, a photograph or drawing, a name or initials of an organization or an individual, a catchphrase or slogan, a mission statement, a URL or social media handle, contact information (e.g., a physical or email address, a phone number, a fax number, etc.), a font, or the like. The graphical identification objects may be received, stored, and processed in a suitable digital format, including image and text file formats.

The system facilitates the transfer of the graphical identification objects to a physical substrate associated with an item in the Custom Branded Marketplace. For example, a physical substrate can correspond to a surface of the item, labeling, packaging, or the like. When the item is sent to a Recipient, the graphical identification objects may be printed, etched, embroidered, or otherwise transferred to the physical substrate. In addition, a synthetic Catalog image (e.g., a thumbnail image or other depiction of the item that has been adapted to include the graphical identification object) may be rendered for display in the Custom Branded Marketplace, e.g., when the Recipient is viewing the Recipient Catalog.

In some embodiments, the system may transmit the graphical identification objects to one or multiple external systems associated with vendors of the items (e.g., via APIs) to create the Custom Branded Marketplace catalog. In the case of multiple vendors, the system can optionally curate the Custom Branded Marketplace to avoid duplication of items (for example, it can decide to list one white 12-oz ceramic coffee mug selected from one of Vendor B and Vendor A, which both offer 12-oz ceramic coffee mugs). The rules for curating the Custom Branded Marketplace can be explicit (such as “always choose vendor A over Vendor B if the product UPC is the same,” or “only allow products from Vendor C if they are rated 3.5 stars or above and from Vendor D if they are rated 4 stars or above,”) or heuristic, or based on past interactions of users of the system with those products, or on any other basis.

If the Sender is physically handing out invitations directly to Recipients, the Sender has several options. In one embodiment, they can run the Sender Process for the desired recipients individually and set a bulk delivery of the Physical Item Invitation so they can hand out the physical invitations. The Sender can also run the Sender Process based on a potential class of Recipient. Examples of recipient classes might include “Annual Trade Show Attendee,” “VP+ level booth visitor,” or “Employee Raffle Winners”. The system would capture information used to generate the Physical Item Invitations, and to deliver them to the Sender or the Sender's selected destination (for example, directly to a trade show venue). They could be printed on cards, or delivered in any form or on any item, the invitations can each have a unique Code 502, and therefore each can be individually traceable during the Recipient Process. This process can create Invitations lacking Recipient information, so in these cases the system may retroactively update these records once the identity of the Recipient is captured during the redemption of the Item.

In other embodiments the Sender process can be run, possibly in an abbreviated form, on demand (e.g., during a conversation with a prospect in a booth) and the Invitation may be printed, texted, or sent through any suitable channel. In another embodiment, rotating codes can be generated, and Physical Invitations can be printed on demand based on the time of day, to match up against booth traffic at a trade show or scanned attendees at an event. In another embodiment, scanning an attendee's trade show, concert, or event ticket may automatically initiate a Sender Process based on the information embedded in their registration. Likewise, the information could be conveyed by an NFC tap, Bluetooth, or any other means.

During the Recipient Process, the physical invitation may not be fully filled out and prepared. In this case, the recommendation that the Recipient sees when they go to the Item Invitation Page 203 may not be personalized to that particular Recipient, but may instead reflect the Sender's selection for the class of Recipients. Both the recommended item shown on the Item Invitation Page 203 and the Item Choice Page 209 as well as the catalog of items available in the Choose Another Item from Marketplace 205 may optionally be limited to Custom Branded Items.

In some embodiments, the system may adaptively improve the personalization of the Recipient Process, including using any available demographics or psychographics that may have been observed or captured during any interaction with the Recipient to update their profile before they access their Invitation. Additionally, observed patterns about the interactions of previous Recipients in the same class can be used to improve recommendations for recipients who have not yet accessed their invitations. For example, if 1000 cards were handed out at a trade show, and of the first 50 people to go through the recipient process, only 10% selected the recommended water bottle, 70% chose the insulated travel mug and 20% selected the stuffed bear, the system could switch the recommendation to the travel mug. Also, since the process is dynamic, new items can be added after an invitation has been issued, and items that go out of stock or otherwise are no longer appropriate can be removed.

During the Recipient Process, the system may capture the Recipient's identity and to populate their profile retroactively. The information gathered can be used to establish demographic, psychographic, interest, and other profiles of the individual, and can help establish a more accurate profile of the overall population of recipients of the Invitation, including those who may not yet have begun the Recipient Process.

In some embodiments, a Custom Branded Item itself may convey a redemption code (for example, a company mug contains a card with a URL and Code on it, or the URL and Code are printed on the bottom of a paperweight). In addition, when the Recipients are unknown (such as trade shows or large company events), or known recipients are gathered at a particular location, bulk Physical Item Invitations may be fulfilled to the particular location.

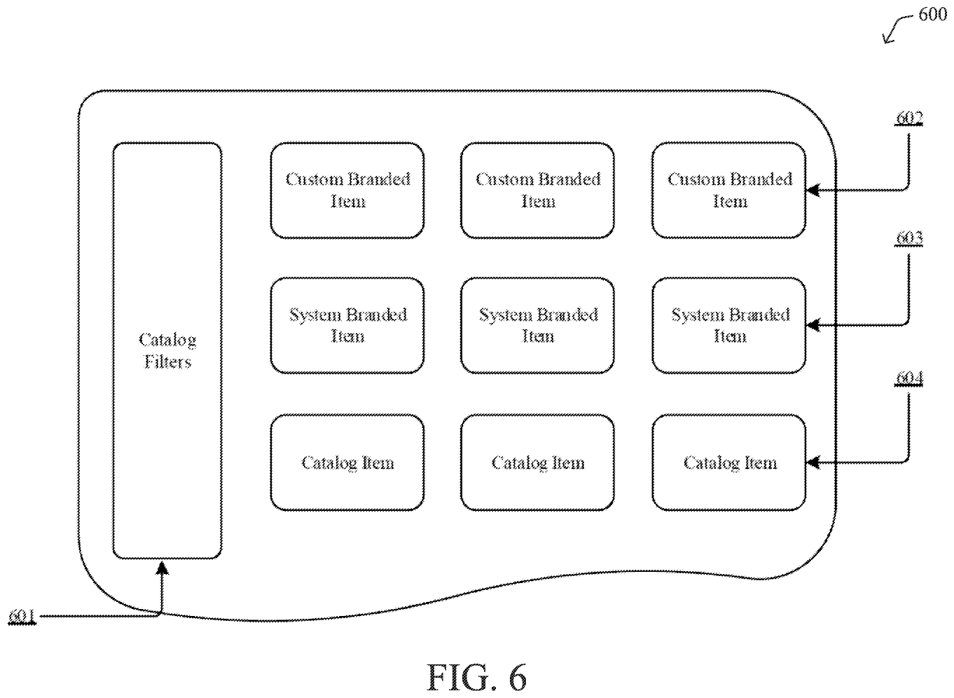

FIG. 6 illustrates an example Recipient Catalog 600, the experience the Recipient has when selecting items other than the recommended item from the sender's catalog. The illustration describes the experience the Recipient may have when using a Custom Branded Marketplace.

Catalog Filters 601 are included on the Recipient Catalog page allowing the Recipient to restrict the number of options shown based on their chosen preferences. Examples of filters include but are not limited to size, color, vendor, brand, etc.

Custom Branded Items 602 are items that are available for the Recipient to view or choose in the Sender's catalog based on Organization, Team or Individual Account preferences. The system may or may not limit the number of Custom Branded Items per catalog page.

A System Branded Item 603 is an item that is optionally available to the Recipient to view or choose in the Sender's catalog based on Organization, Team or Individual Account preferences.

A Catalog Item 604 is an item that is optionally from the default catalog of items. This is available to the Recipient to view or choose in the Sender's catalog based on Organization, Team or Individual Account preferences.

In some embodiments, one or more types of items may be excluded. For example, a Custom Branded Marketplace may exclude one or both of System Branded Items 603 and Catalog Items 604.

In some embodiments, the system may be configured for “kitting” together custom branded items/products. In instances where a Sender may want to give a Recipient a certain value of Items, say $150 worth of company gear for a new employee on their first day, the system may allow the Recipient to select multiple items from the Recipient Catalog and maintain a shopping cart or running total value or some other means of displaying the remaining value available to the Recipient.

In addition to allowing Sender organizations to provide graphical identification objects (e.g., logos, company names, and colors), the system may allow for external designers to provide graphical identification objects. Accordingly, the system may include a Designer Marketplace where designers may be chosen or compete for the right to design a specific item, to create a design that will be broadly re-used by an organization, or to become a retained or preferred designer of a particular firm. This can be accomplished through API integration to third-party design marketplaces (such as 99designs), or by a marketplace mechanism where specific design tasks are put up for competition.

Vendors that provide promotional products run the gamut from sophisticated on-demand custom print shops to mom-and-pop one-off custom silk-screening places to warehouses and logistics experts. Accordingly, the system may include a Vendor Marketplace that includes curated vendors that have been integrated into the platform so that the experience for the Sender organization is seamless, e.g., their graphical identification objects (e.g., logo and color) are accurately reproduced on items from different vendors, and the items delivered meet the selected standard of quality, price, or other criteria.

New Vendor Onboarding requires that vendors be connected into that marketplace and that integrations into their systems be established, whether by API or manually or by other means, and that sufficient testing be performed to certify the performance of the vendor to produce promotional products within the marketplace.

The Marketplace may optionally have features to compare or rate vendor performance, which can be gathered passively by observing interactions with the system and performance of their steps of the process, as well as Sender and Receiver preferences and ratings of their Items, as well as actively by seeking ratings and reviews from users. Optionally vendors could bid on particular business or orders.

During a New Vendor Onboarding process, vendors are connected into the marketplace and integrations into their external systems are established, e.g., by API integration. Testing may be performed to certify the performance of the vendor to produce promotional products within the marketplace.

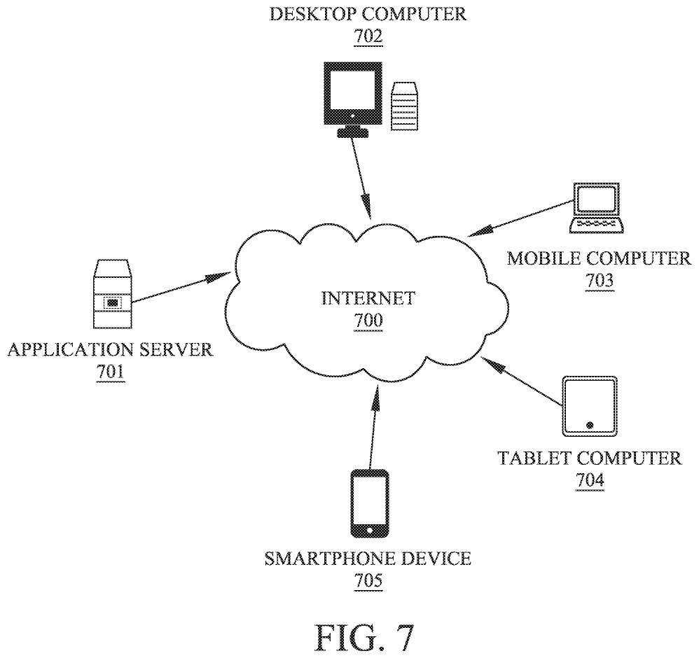

FIG. 7 illustrates an exemplary Computer Network System according to some embodiments. A public network 701 is coupled to an application server 702 that performs one or more functions associated with the above-described system. Users of the system (e.g., Senders, Recipients, Vendors, Designers, etc.) access the public network 701 to communicate with application server 702. Users can connect via desktop computer 703, mobile computer 704, tablet compute 705, smartphone 706, or another computing device. The form of the connection can be via an interactive user interface, application programming interface, web browser (desktop or mobile), mobile device app, or the like.

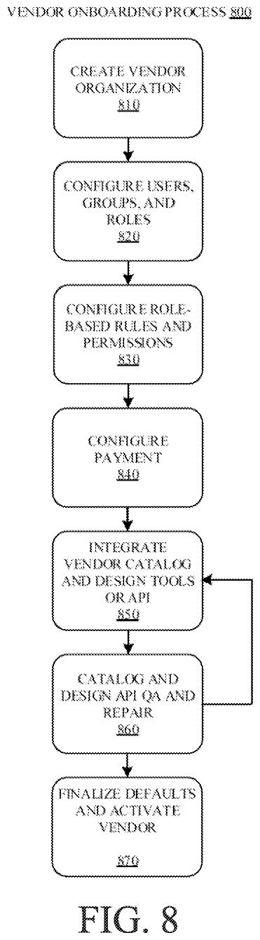

FIG. 8 depicts a vendor onboarding process 800 for enrolling a new vendor. In step 810 a new Vendor organization is created, along with base attributes such as name, contact information, URL, etc. In step 820, Users, Groups, and Roles are created to aid in the configuration and management of permissions, rules, settings, and administration. In step 830, role-based permissions and rules are set up to control which users have access to various functions, such as the ability to set prices or discounts, to add or remove authorized products, to appeal or approve customer service requests, etc. In step 840, the settings for managing payments to the Vendor are configured.

In step 850, the Vendor's catalog is integrated into the system catalog, and the Vendor's design tools are integrated into the Vendor Marketplace. Aspects of the integration can be done via APL The selection of items from the Vendor catalog may be done based on any number of criteria, such as selecting all items from a particular vendor, or the most popular, or the ones with the highest rating, or the ones at a certain price point, or those that had been curated in some particular way—for example, selected for quality, value, and consistency. The design tools the Vendor provides may be made available by the Vendor via API, or only via a web interface, or sometimes only via other means (such as via email interaction with the Vendor's in-house designer). In each case, in step 850 the system creates an API such that the Vendor's catalog of unbranded items/products can appear to a Sender or a Recipient as they will appear once they are produced with the Sender Organization's graphical identification objects (such as their logo) placed on the item.

There are significant technical challenges associated with accurately transferring graphical identification objects onto products (or product packaging) and accurately generating synthetic images of products that include graphical identification objects, particularly when there is a diversity of products from a diversity of vendors with significantly different capabilities.

For example, different Vendors may have variations in the ways they treat different colors or fonts, or may have different capabilities for turnaround times customizing items in their inventory.

To address these challenges, for some vendors, the system may send the graphical identification objects without adjustment to the Vendor's API, and the Vendor's external system may generate and return a synthetic Catalog image (e.g., a thumbnail image). For other vendors, the system may make adjustments (e.g., color or font adjustments) to the graphical identification objects before sending them to the Vendor's API to ensure color consistency across vendors.

One or more adjustments may be prepared in advance of sending the graphical identification objects to the Vendor's API, and the adjusted graphical identification objects may be stored by the system. Other adjustments may be made in a real-time or just-in-time manner, in which case the corresponding adjusted graphical identification objects may not be stored by the system.

In some embodiments, the system may receive product images (e.g., blank or generic images) from the Vendor, and the system may generate synthetic images by rendering the graphical identification objects (with or without adjustment) onto the received product images. Subsequently, the system may send graphical identification objects (with or without adjustment) to the Vendor on demand after a Recipient has placed an order for an item.

Because items may appear side-by-side in the Custom Branded Marketplace, inconsistency and quality of execution from one vendor to the next is readily apparent. Thus, Quality Assurance is performed at both the Catalog/AP! level and the item level (step 860). Color accuracy between initial design and final delivered products is verified and compared to known standards and to other Vendors, and within the product line of the Vendor itself Adjustments can be made to compensate for bias in vendor design processes or color palettes (say, a tendency to color-shift toward over-saturated reds on t-shirts), and those repairs can be encoded as color masks which can be persisted at the API-level, the product-level, or at various other levels in the hierarchy. Similarly, such repairs can be captured and encoded for other known biases and transformations, such as image quality downsampling, image cropping, image size reduction, font substitution, etc. Also, products can be annotated with their stability, consistency, and frequency of change. These annotations can help at Catalog render time to determine whether to use cached or rendered product images.

Based on whether quality issues identified in 860 are addressable at the item-level, the API-level, or not at all, additional updates may be performed at step 850, which may include eliminating certain problematic items from the Vendor's active catalog. For those items or Vendors where consistency or quality is not high enough to reliably generate synthetic Catalog images, placeholder Catalog Images can be used in the API that show an indication that they are not an accurate representation of the final design, for example they could be conspicuously watermarked with the word “SAMPLE IMAGE.”.

In step 870, the Vendor organization enrollment is completed.

It should be apparent to one of ordinary skill in the art that many of the above steps can take place in different order, or are optional, or can be added to in various embodiments.

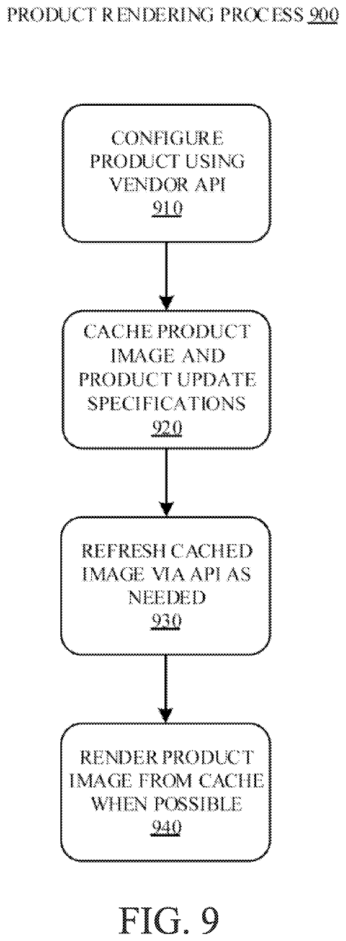

FIG. 9 illustrates a product rendering process 900 for establishing and populating caches for synthetic Catalog images and then keeping them up to date and using them for image rendering. When a new product is added to a Custom Branded Marketplace (step 910), the product is configured using an API to have the correct settings, logo/image placement, colors, font, etc. Generally, as part of that process, a proof image is produced by the Vendor's API, or else as part of the Vendor Onboarding process a wrapper API was created to generate a proof image. That image, along with variations (for example, for different sizes or colors, or different genders of the same article of clothing) may be generated and stored in step 920, along with other information about the stability of the product itself, and how frequently the cache should be refreshed. Based on that cache refresh cycle, the system may periodically re-initiate the API (step 930) to re-generate the images and re-cache them. The system may use various techniques to optimize cache refreshes, including randomly refreshing caches, forcing refreshes of older images, and increasing the cash expiration frequency of any item where a cache refresh didn't result in the generation of an identical image to the one already in the cache. Cached images can be refreshed at various frequencies, including refreshing them every time the image is rendered as a precautionary measure (in this case, the cache provides a speed and stability enhancement in the user interface).

In step 940, when the user interface renders a synthetic Catalog image, the system can

access the image from the cache provided that the settings used when generating the image were the same as the user's current settings for that variant of the product.

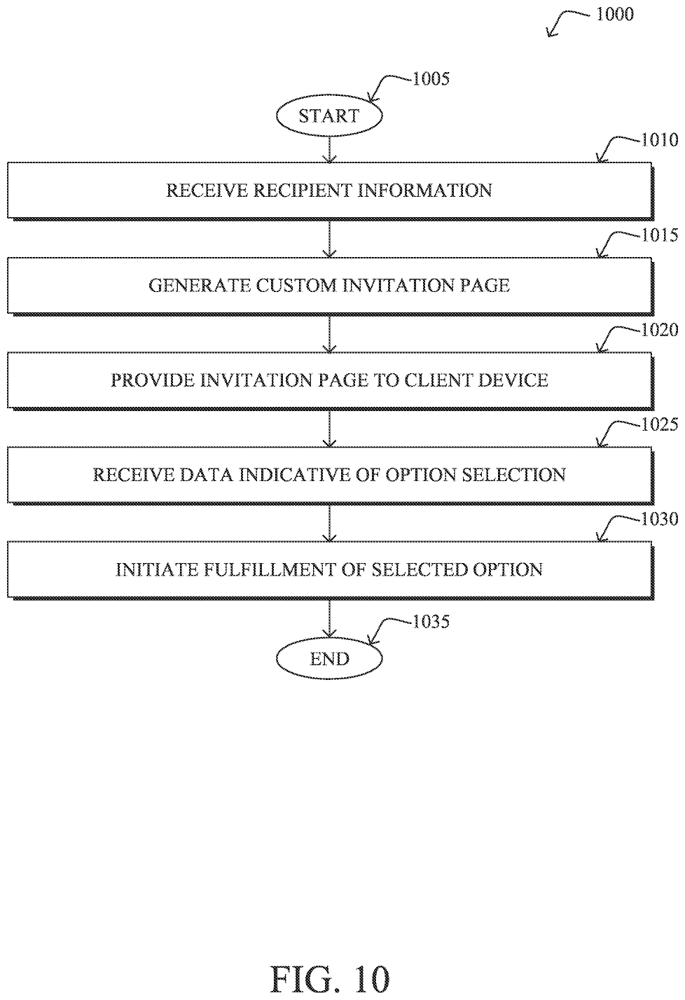

FIG. 10 illustrates a diagram of a simplified procedure 1000 for initiating fulfillment of a selected option via a custom invitation page, according to various embodiments. In general, procedure 1000 may be performed by a computing device executing specialized instructions, such as a server in a network. As shown, procedure 1000 may start at step 1005 and continues on to step 1010 where, as described in greater detail above, the server may receive recipient information for an intended recipient of a branded item. For example, the server may provide one or more pages to a user interface that allows a sender of branded items/merchandise to specify the intended recipient of a branded item. In various embodiments, the recipient information may also include, but is not limited to, any or all of the following: contact information for the intended recipient (e.g., email address, phone number, social media account, mailing address, etc.), one or more item selection rules that can be used to select branded items for the recipient, other information about the intended recipient (e.g., job title, etc.), or the like.

At step 1015, as detailed above, the server may generate a custom invitation page for the intended recipient, based on the received recipient information. In one embodiment, the server offers the branded item and a plurality of other options as options to the intended recipient. For example, the custom invitation page may indicate to the intended recipient that the branded item has been selected for them, but the intended recipient has the option to decline the offer outright, opt for a charitable donation in lieu of the item, or select from among a set of other branded items.

At step 1020, the server may provide the custom invitation page to a client device associated with the intended recipient. In some embodiments, the invitation page may take the form of a webpage. In such cases, the client device may navigate to the webpage either directly or indirectly. For example, in some cases, the intended recipient may be prompted on a first page to enter a code associated with the invitation page. In turn, the first page may redirect the client device to the invitation page, thereby allowing the intended recipient to select which gift to receive, if any.

At step 1025, as detailed above, the server may receive, from the client device, data indicative of a selection of one of the options offered via the custom invitation page. For example, the intended recipient may opt to receive the branded item first offered by the invitation page, opt for a charitable donation in lieu of receiving the branded item, opt for another branded item presented via a recipient catalog, or decline all other options outright.

At step 1030, the server may initiate fulfillment of the selected option, as described in greater detail above. In various embodiments, the server may do so by communicating the selected option to another device. In turn, the other device transfers a graphical identification object onto a physical substrate that identifies a sender of the branded item. For example, if the intended recipient opted for the branded item, or another branded item, the server may initiate the manufacture and/or shipping of the selected item to the intended recipient. Procedure 1000 then ends at step 1035.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

At various points in the system, the actions taken by users, as well as interactions with internal and external systems, are optionally observed and stored. The integration of data from external systems associated with the Sender organization, such as CRM systems, is also contemplated. The system can make use of this stored data for analysis, reporting, optimization, profiling, and recommendation. And other reports are capable of standard statistical techniques.

Accordingly, in various embodiments, a method is disclosed herein. The method comprises: receiving, at a server, recipient information for an intended recipient of a branded item; generating, by the server and based on the recipient information, a custom invitation page that offers the branded item and a plurality of other options as options to the intended recipient; providing, by the server, the custom invitation page to a client device associated with the intended recipient; receiving, at the server and from the client device, data indicative of a selection of one of the options offered via the custom invitation page; and initiating, by the server, fulfillment of the selected option.

In one embodiment, initiating fulfillment of the selected option comprises: communicating, by the server, the selected option to another device, wherein the other device transfers a graphical identification object onto a physical substrate that identifies a sender of the branded item. In another embodiment, the selected option comprises a charitable donation in lieu of receiving a branded item. In a further embodiment, the recipient information comprises one or more item selection rules. In an additional embodiment, generating, by the server and based on the recipient information, the custom invitation page that offers the branded item and the plurality of other options as options to the intended recipient comprises: identifying, by the server, a plurality of alternate items associated with a sender of the branded item, based on the one or more item selection rules; and generating, by the server, a recipient catalog that displays the alternate items as options via the custom invitation page. In another embodiment, generating, by the server and based on the recipient information, the custom invitation page comprises: including at least a portion of the recipient information on the custom invitation page. In a further embodiment, generating, by the server and based on the recipient information, the custom invitation page comprises: generating, by the server, a unique code associated with the custom invitation page. In yet another embodiment, providing the custom invitation page to the client device associated with the intended recipient comprises: receiving the unique code at the server, wherein the server provides the custom invitation page to the client device in response to receiving the unique code. In another embodiment, the method further comprises: sending, by the server, the unique code to the client device via a digital message. In a further embodiment, the method further comprises: including, by the server, a uniform resource locator (URL) for a webpage that redirects to the custom invitation page when the unique code is entered via the webpage.

In further embodiments, a tangible, non-transitory computer-readable medium comprising instructions executable by a processor of a server for executing a process is disclosed. The process comprises receiving, at the server, recipient information for an intended recipient of a branded item; generating, by the server and based on the recipient information, a custom invitation page that offers the branded item and a plurality of other options as options to the intended recipient; providing, by the server, the custom invitation page to a client device associated with the intended recipient; receiving, at the server and from the client device, data indicative of a selection of one of the options offered via the custom invitation page; and initiating, by the server, fulfillment of the selected option.

In some embodiments, an apparatus is disclosed. The apparatus comprises one or more network interfaces; a processor coupled to the network interfaces and configured to execute one or more processes; and a memory configured to store a process executable by the processor. The process when executed is configured to: receive recipient information for an intended recipient of a branded item; generate, based on the recipient information, a custom invitation page that offers the branded item and a plurality of other options as options to the intended recipient; provide the custom invitation page to a client device associated with the intended recipient; receive, from the client device, data indicative of a selection of one of the options offered via the custom invitation page; and initiate fulfillment of the selected option.

Various embodiments of the systems and methods described herein may be implemented by a computer system with one or more hardware processors connected to a network. The system can be run on at least one server, which can be physical or virtualized, and in one or multiple data centers. The Receiver, Sender and other users of the system can access the system via terminals connected to the system via a network, such as the internet, and those terminals may be desktop, laptop, tablet, mobile, or the like.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method, comprising:
receiving, at a server, recipient information for an intended recipient of a branded item;
generating, by the server and based on the recipient information, a custom invitation page that offers the branded item and a plurality of other options as options to the intended recipient;
providing, by the server, the custom invitation page to a client device associated with the intended recipient;
receiving, at the server and from the client device, data indicative of a selection of one of the options offered via the custom invitation page; and
initiating, by the server, fulfillment of the selected option.

2. The method as in claim 1, wherein initiating fulfillment of the selected option comprises:
communicating, by the server, the selected option to another device, wherein the other device transfers a graphical identification object onto a physical substrate that identifies a sender of the branded item.

3. The method as in claim 1, wherein the selected option comprises a charitable donation in lieu of receiving a branded item.

4. The method as in claim 1, wherein the recipient information comprises one or more item selection rules.

5. The method as in claim 4, wherein generating, by the server and based on the recipient information, the custom invitation page that offers the branded item and the plurality of other options as options to the intended recipient comprises:
identifying, by the server, a plurality of alternate items associated with a sender of the branded item, based on the one or more item selection rules; and
generating, by the server, a recipient catalog that displays the alternate items as options via the custom invitation page.

6. The method as in claim 1, wherein generating, by the server and based on the recipient information, the custom invitation page comprises:
including at least a portion of the recipient information on the custom invitation page.

7. The method as in claim 1, wherein generating, by the server and based on the recipient information, the custom invitation page comprises:
generating, by the server, a unique code associated with the custom invitation page.

8. The method as in claim 7, wherein providing the custom invitation page to the client device associated with the intended recipient comprises:
receiving the unique code at the server, wherein the server provides the custom invitation page to the client device in response to receiving the unique code.

9. The method as in claim 7, further comprising:
sending, by the server, the unique code to the client device via a digital message.

10. The method as in claim 9, further comprises:
including, by the server, a uniform resource locator (URL) for a webpage that redirects to the custom invitation page when the unique code is entered via the webpage.

11. A tangible, non-transitory computer-readable medium comprising instructions executable by a processor of a server for executing a process comprising:
receiving, at the server, recipient information for an intended recipient of a branded item;
generating, by the server and based on the recipient information, a custom invitation page that offers the branded item and a plurality of other options as options to the intended recipient;
providing, by the server, the custom invitation page to a client device associated with the intended recipient;
receiving, at the server and from the client device, data indicative of a selection of one of the options offered via the custom invitation page; and
initiating, by the server, fulfillment of the selected option.

12. The computer-readable medium as in claim 11, wherein initiating fulfillment of the selected option comprises:
communicating, by the server, the selected option to another device, wherein the other device transfers a graphical identification object onto a physical substrate that identifies a sender of the branded item.

13. The computer-readable medium as in claim 11, wherein the selected option comprises a charitable donation in lieu of receiving a branded item.

14. The computer-readable medium as in claim 11, wherein the recipient information comprises one or more item selection rules.

15. The computer-readable medium as in claim 14, wherein generating, by the server and based on the recipient information, the custom invitation page that offers the branded item and the plurality of other options as options to the intended recipient comprises:
identifying, by the server, a plurality of alternate items associated with a sender of the branded item, based on the one or more item selection rules; and
generating, by the server, a recipient catalog that displays the alternate items as options via the custom invitation page.

16. The computer-readable medium as in claim 11, wherein generating, by the server and based on the recipient information, the custom invitation page comprises:
including at least a portion of the recipient information on the custom invitation page.

17. The computer-readable medium as in claim 11, wherein generating, by the server and based on the recipient information, the custom invitation page comprises:
generating, by the server, a unique code associated with the custom invitation page.

18. The computer-readable medium as in claim 17, wherein providing the custom invitation page to the client device associated with the intended recipient comprises:
receiving the unique code at the server, wherein the server provides the custom invitation page to the client device in response to receiving the unique code.

19. The computer-readable medium as in claim 11, wherein the process further comprises:
sending, by the server, the unique code to the client device via a digital message; and
including, by the server, a uniform resource locator (URL) for a webpage that redirects to the custom invitation page when the unique code is entered via the webpage.

20. An apparatus, comprising:
one or more network interfaces;
a processor coupled to the network interfaces and configured to execute one or more processes; and
a memory configured to store a process executable by the processor, the process when executed configured to:
receive recipient information for an intended recipient of a branded item;
generate, based on the recipient information, a custom invitation page that offers the branded item and a plurality of other options as options to the intended recipient;
provide the custom invitation page to a client device associated with the intended recipient;
receive, from the client device, data indicative of a selection of one of the options offered via the custom invitation page; and
initiate fulfillment of the selected option.
